(19) United States
(12) Patent Application Publication
(10) Pub. No.: US 2026/0196556 A1
(43) Pub. Date: Jul. 9, 2026

(54) PVDF-HFP-@PEG-BASED ELECTROLYTE, PREPARATION METHOD THEREOF, AND LITHIUM BATTERY INCLUDING SAME

(71) Applicant: Fuzhou University, Fuzhou (CN)

(72) Inventors: Yun ZHENG, Fuzhou (CN); Jiujun ZHANG, Fuzhou (CN)

(73) Assignee: Fuzhou University, Fuzhou (CN)

(21) Appl. No.: 19/437,363

(22) Filed: Dec. 31, 2025

(30) Foreign Application Priority Data
Jan. 3, 2025 (CN) 202510011391.5

(51) Int. Cl. H01M 10/0565; C08G 81/02; H01M 10/0525

(52) U.S. Cl. CPC H01M 10/0565; C08G 81/025; H01M 10/0525; H01M 2300/0082

(57) ABSTRACT

A poly(vinylidene fluoride-co-hexafluoropropylene) (PVDF-HFP)-@polyethylene glycol (PEG)-based electrolyte, a preparation method thereof, and a lithium battery including the same are provided. Two polymer phases are mixed in a solvent to produce a precursor solution, and the precursor solution is continuously stirred at room temperature for thorough mixing, then casted, and subjected to room-temperature drying and high-temperature crosslinking successively under vacuum to produce a polymer-based membrane. The polymer-based membrane is soaked in an electrolyte to produce a target polymer-based electrolyte. The target polymer-based electrolyte is cut into an electrolyte sheet with specific dimensions, and then used to assemble a lithium metal battery. With a “slight crosslinking” strategy proposed herein, polyethylene glycol diamine can be combined with a PVDF-HFP matrix to produce a crosslinked polymer possessing a stable structure without introducing any catalyst or crosslinking agent. This crosslinked polymer can significantly enhance the electrochemical performance, mechanical properties, and chemical/thermal stability of an electrolyte.

### CROSS REFERENCE TO THE RELATED APPLICATIONS

This application is based upon and claims priority to Chinese Patent Application No. 202510011391.5, filed on Jan. 3, 2025, the entire contents of which are incorporated herein by reference.

### TECHNICAL FIELD

The present disclosure belongs to the technical field of polymer electrolyte materials for lithium batteries, and primarily relates to a method for preparing a crosslinked polymer electrolyte by specifically bonding polyethylene glycol diamine (NH₂-PEG-NH₂) with poly(vinylidene fluoride-co-hexafluoropropylene) (PVDF-HFP), and a use of the crosslinked polymer electrolyte in a metal battery.

### BACKGROUND

Currently, lithium-ion batteries are primarily liquid batteries based on volatile organic electrolytes. These liquid batteries enable an energy density of only 250 Wh/kg, and have potential safety risks. Thus, these liquid batteries can no longer adequately meet the urgent demand for high-performance energy storage devices. In recent years, polymer-based lithium metal batteries have garnered increasing attention due to high intrinsic safety, excellent flexibility, and high theoretical energy density.

As a key component of polymer-based lithium metal batteries, polymer electrolytes have attracted extensive attention from both academic and business communities. Studies have shown that stably retaining a small amount of an electrolyte within a polymer electrolyte matrix to produce a quasi-solid-state polymer electrolyte is an effective strategy for enhancing the overall performance of both an electrolyte and a battery. The design and preparation of polymer matrices, as a core component of such electrolytes, are of vital importance. The current materials extensively studied include polyethylene oxide (PEO), polyvinylpyrrolidone (PVP), polyacrylonitrile (PAN), polymethyl methacrylate (PMMA), polyvinylidene fluoride (PVDF), PVDF-hexafluoropropylene (HFP), etc. Due to advantages such as high dielectric constant, excellent mechanical properties, and stable electrochemical properties, PVDF-HFP has been highly valued and widely studied by researchers.

However, PVDF-HFP exhibits drawbacks such as high crystallinity, low affinity with electrolytes, and poor interfacial stability with electrodes. In view of these drawbacks, PVDF-HFP is commonly combined with a polyethylene glycol (PEG)-based polymer that possesses complementary properties to PVDF-HFP to produce a PVDF-HFP-PEG polymer, thereby improving the overall performance. The primary strategies currently used to introduce PEG into PVDF-HFP to produce PVDF-HFP-PEG polymers include physical blending, physical crosslinking, chemical crosslinking, etc. Although these strategies can integrate the advantages of the related two materials to some extent, there are still significant challenges. The physical blending strategy is often faced with phase separation due to incomplete miscibility of two phases. The physical and chemical crosslinking strategies may introduce impurities and suffer from poor stability caused by weak bonding. Ultimately, these issues severely compromise critical properties of the corresponding lithium metal batteries, including a power density, a cycling life, and safety.

To address the aforementioned challenges, the present invention proposes a unique crosslinking strategy of “slight crosslinking”. With this crosslinking strategy, a PVDF-HFP-@PEG-based electrolyte with significantly enhanced key properties including ionic conductivity, mechanical properties, and chemical/thermal stability can be successfully prepared without introducing any catalyst or crosslinking agent.

### SUMMARY

In view of the existing scientific and technological challenges, the present disclosure proposes, for the first time, a “slight crosslinking” strategy in the field of electrolytes for lithium metal batteries. This strategy is used to prepare a PVDF-HFP-based mildly crosslinked polymer (PVDF-HFP-@PEG) membrane with a specific structure, which can significantly improve both the mechanical and electrochemical properties of a corresponding electrolyte. A polymer electrolyte prepared accordingly can effectively promote the optimization of key electrochemical properties of associated lithium metal batteries.

The present disclosure adopts the following technical solutions:

A preparation method of a PVDF-HFP-@PEG-based electrolyte is provided, including: soaking a PVDF-HFP-@PEG polymer membrane in an electrolyte under an inert atmosphere, and drying to produce the PVDF-HFP-@PEG-based electrolyte, where a structural formula of the PVDF-HFP-@PEG polymer membrane is as follows:

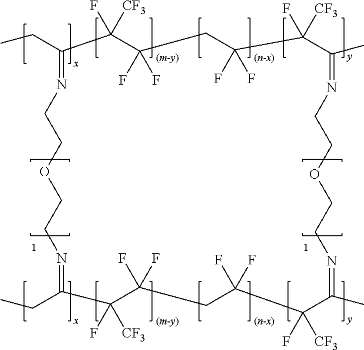

where x is a positive integer greater than 0 and less than n, y is a positive integer greater than 0 and less than m, at least one of x and y is greater than or equal to 1, and values of m and n are determined based on PVDF-HFP; and
a preparation process of the PVDF-HFP-@PEG polymer membrane is as follows:

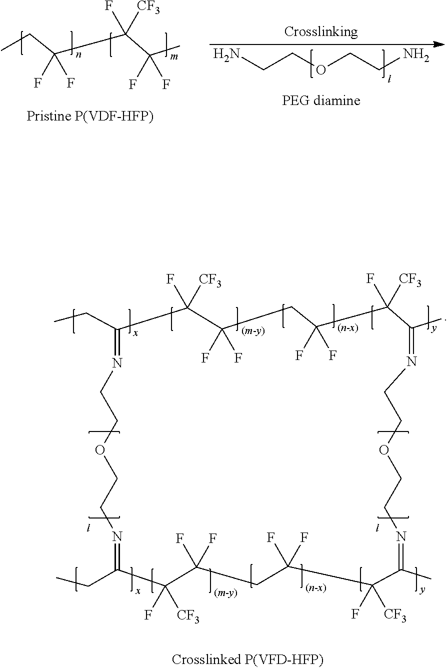

The preparation process of the PVDF-HFP-@PEG polymer membrane specifically includes: adding the PVDF-HFP and NH₂-PEG-NH₂ to a solvent, and thoroughly mixing to produce a precursor mixed solution; spreading the precursor mixed solution into a thin liquid layer, and vacuum-drying at room temperature; and conducting a crosslinking reaction under vacuum at 130° C. to 230° C. to produce the PVDF-HFP-@PEG polymer membrane. A mass ratio of the PVDF-HFP to the NH₂-PEG-NH₂ is 2-6:1. Preferably, the vacuum-drying at room temperature is conducted for 12 h to 48 h, and the crosslinking reaction is conducted for 0.5 h to 5 h.

The solvent is one of N,N-dimethylformamide (DMF), N-methylpyrrolidone (NMP), acetonitrile (CH₃CN), N,N-dimethylacetamide (DMAC), dimethyl sulfoxide (DMSO), and hexamethylphosphoramide (HMPA).

The electrolyte includes a metal salt and an organic solvent, and the metal salt includes, but is not limited to, one of a lithium salt, a sodium salt, and a zinc salt. The lithium salt is one or more of lithium bis(trifluoromethanesulfonyl)imide (LiTFSI), lithium tetrafluoroborate (LiBF₄), lithium hexafluorophosphate (LiPF₆), lithium perchlorate (LiClO₄), lithium bis(oxalato)borate (LiBOB), lithium difluoro(oxalato)borate (LiDFOB), and lithium bis(fluorosulfonyl)imide (LiFSI), and a concentration of the lithium salt in the electrolyte is 0.5 mol/L to 3 mol/L; the sodium salt is one or more of sodium hexafluorophosphate (NaPF₆), sodium trifluoromethanesulfonate (NaOTF), sodium bis(fluorosulfonyl)imide (NaFSI), sodium bis(trifluoromethanesulfonyl)imide (NaTFSI), sodium tetrafluoroborate (NaBF₄), sodium bis(oxalato)borate (NaBOB), sodium difluoro(oxalato)borate (NaDFOB), and sodium perchlorate (NaClO₄), and a concentration of the sodium salt in the electrolyte is 0.5 mol/L to 3 mol/L; and the zinc salt is one or more of zinc sulfate (ZnSO₄) and zinc trifluoromethanesulfonate (ZnOTF), and a concentration of the zinc salt in the electrolyte is 0.5 mol/L to 3 mol/L. The organic solvent is one or more of 1,3-dioxolane (DOL), 1,2-dimethoxyethane (DME), 1,1,2,2-Tetrafluoroethyl-2,2,2-trifluoroethyl ether (TTE), ethylene carbonate (EC), vinylene carbonate (VC), fluoroethylene carbonate (FEC), dimethyl carbonate (DMC), and diethyl carbonate (DEC).

A PVDF-HFP-@PEG-based electrolyte prepared by the preparation method of a PVDF-HFP-@PEG-based electrolyte is provided. A use of the PVDF-HFP-@PEG-based electrolyte in a lithium battery is provided, where the PVDF-HFP-@PEG-based electrolyte is arranged between a cathode and an anode to assemble the lithium battery.

Compared with the prior art, the present disclosure has the following beneficial effects:

(1) The present disclosure enables the preparation of a PVDF-HFP-@PEG-based polymer electrolyte with elastomeric properties. Such a polymer electrolyte exhibits strong mechanical properties, and can adapt to volume changes during long-term lithium plating and stripping processes. Moreover, this polymer electrolyte can maintain excellent interfacial contact with electrodes for a long time, thereby reducing the interfacial resistance and suppressing the growth of lithium dendrites.

(2) The present disclosure enables the preparation of a PVDF-HFP-@PEG-based polymer electrolyte with an ultra-high dielectric constant. Such a polymer electrolyte can significantly promote the dissociation of lithium salts to increase the concentration of free Li⁺. Thus, this polymer electrolyte can improve the capacity of a corresponding lithium battery, and reduce the formation of “dead lithium” during long-term charge-discharge cycles of a corresponding lithium battery to guarantee Coulombic efficiency, thereby optimizing the long-term cycling stability of the battery.

(3) The present disclosure enables the preparation of a PVDF-HFP-@PEG-based polymer electrolyte with a unique configuration. A PEG bridging chain present in such a polymer electrolyte expands the original interchain spacing of the PVDF-HFP matrix. Additionally, the abundant oxygen sites introduced on the PEG chain provide ample, diverse, and efficient pathways for Li⁺ migration.

(4) The present disclosure enables the preparation of a PVDF-HFP-@PEG-based polymer electrolyte with a unique configuration. Such a polymer electrolyte possesses excellent mechanical properties, thermal stability, and electrolyte retention capacity. When subjected to an external force or in a high-temperature environment, this polymer electrolyte can effectively maintain the stability of its own structure and shape and retain an electrolyte, which can significantly boost the operational safety of a corresponding lithium battery.

(5) Polymer electrolytes that can be prepared by the present disclosure have a uniform component distribution and a stable internal structure, and demonstrate exceptional Li⁺ dissociation and transport capabilities. A lithium metal battery assembled with such a polymer electrolyte exhibits prominent electrochemical properties in both high-current tolerance and fast-charging performance tests.

(6) The polymer electrolyte involved in the present disclosure can be prepared by a simple and easy-to-operate process with strong raw material cost competitiveness, which is conducive to industrial-scale production and expansion.

### BRIEF DESCRIPTION OF THE DRAWINGS

FIG. 1 shows the high-rate long-term cycling performance of a lithium metal battery assembled with a PVDF-HFP-@PEG-based electrolyte prepared in Example 1;

FIG. 2 shows the comparison of long-term cycling performance of lithium metal batteries assembled with the PVDF-HFP-@PEG-based electrolyte prepared in Example 1 and a PVDF-HFP-based electrolyte prepared in Comparative Example 1, respectively;

FIG. 3 shows surface scanning electron microscopy (SEM) images of a PVDF-HFP-@PEG polymer membrane prepared in Example 1, a PVDF-HFP polymer membrane prepared in Comparative Example 1, and a PVDF-HFP+PEG polymer membrane prepared in Comparative Example 2;

FIG. 4 shows the comparison of thermal stability test results of the PVDF-HFP-@PEG polymer membrane prepared in Example 1, the PVDF-HFP polymer membrane prepared in Comparative Example 1, and the PVDF-HFP+PEG polymer membrane prepared in Comparative Example 2;

FIG. 5 shows the comparison of Fourier transform infrared (FT-IR) spectroscopy results of the PVDF-HFP-@PEG polymer membrane prepared in Example 1, the PVDF-HFP polymer membrane prepared in Comparative Example 1, and the PVDF-HFP+PEG polymer membrane prepared in Comparative Example 2;

FIG. 6 shows the comparison of stress-strain curves of the PVDF-HFP-@PEG polymer membrane prepared in Example 1, the PVDF-HFP polymer membrane prepared in Comparative Example 1, and the PVDF-HFP+PEG polymer membrane prepared in Comparative Example 2;

FIG. 7 shows the comparison of thermogravimetric analysis (TGA) results of the PVDF-HFP-@PEG-based electrolyte prepared in Example 1, the PVDF-HFP-based electrolyte prepared in Comparative Example 1, and a PVDF-HFP+PEG-based electrolyte prepared in Comparative Example 2;

FIG. 8 shows the high-rate long-term cycling performance of a lithium metal battery assembled with a PVDF-HFP-@PEG-based electrolyte prepared in Example 2; and

FIG. 9 shows the high-loading long-term cycling performance of a lithium metal battery assembled with a PVDF-HFP-@PEG-based electrolyte prepared in Example 3.

### DETAILED DESCRIPTION OF THE EMBODIMENTS

In order to make the objectives, technical solutions, and advantages of the embodiments of the present disclosure clear, the technical solutions of the present disclosure will be described clearly and completely below with reference to examples.

### Example 1

(1) Preparation of a PVDF-HFP-@PEG polymer membrane: 300 mg of PVDF-HFP (purchased from Aladdin, CAS No.: 9011-17-0) and 100 mg of NH₂-PEG-NH₂ were weighed and mixed in a glove box, and then DMF was added for dissolution to produce a precursor solution. The precursor solution was continuously stirred at room temperature for 12 h to produce a homogeneous precursor solution. The homogeneous precursor solution was poured into a glass dish with a diameter of 8 cm, vacuum-dried at room temperature for 12 h, and then subjected to vacuum crosslinking at 200° C. for 2 h to produce the PVDF-HFP-@PEG polymer membrane.

(2) Preparation of a PVDF-HFP-@PEG-based electrolyte: An electrolyte (2 M LiTFSI in DOL+DME, a volume ratio of DOL to DME was 3:1) was first prepared. Then, the PVDF-HFP-@PEG polymer membrane was soaked in the electrolyte for 48 h, then dried, and cut to produce the PVDF-HFP-@PEG-based electrolyte.

(3) Preparation of a cathode: LiFePO₄ (LFP), conductive carbon black, and PVDF were mixed in a mass ratio of 8:1:1 and fully ground, then an appropriate amount of DMF was added, and thorough stirring was conducted to produce a slurry. The slurry was evenly coated onto an aluminum foil. A coated aluminum foil was then vacuum-dried in an oven for 24 h, cut into a disc with a diameter of 10 mm, and stored in a glove box for later use.

(4) Assembly of a lithium metal battery: The cathode and the electrolyte were placed in a glove box, and a CR2032 button battery was then assembled according to the following assembly sequence: cathode shell, cathode, electrolyte, anode, spacer, spring plate, and anode shell.

The charge-discharge performance of the assembled button battery was tested at room temperature using a Land CT3002A battery testing system.

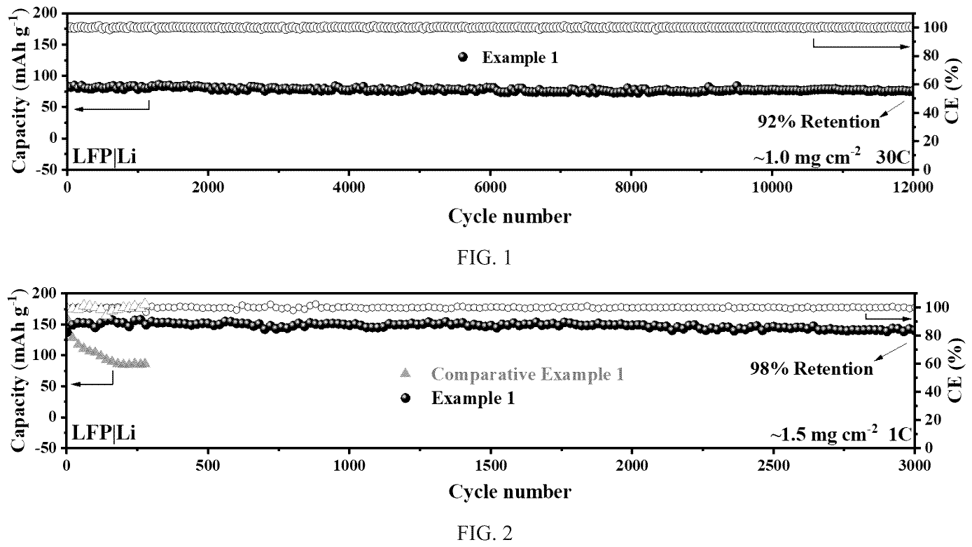

The lithium metal battery was assembled with the polymer electrolyte, and subjected to electrochemical performance tests. The corresponding high-rate long-term cycling performance data was shown in FIG. 1. As shown in FIG. 1, after the Li|PVDF-HFP-@PEG|LiFePO₄ lithium metal battery operated at 30 C for 12000 stable cycles, a capacity retention rate was 92% and a Coulombic efficiency was 99.9%, indicating exceptional performance.

### Comparative Example 1

(1) Preparation of a PVDF-HFP polymer membrane: 300 mg of PVDF-HFP was weighed in a glove box, and then DMF was added for dissolution to produce a precursor solution. The precursor solution was continuously stirred at room temperature for 12 h to produce a homogeneous precursor solution. The homogeneous precursor solution was poured into a glass dish with a diameter of 8 cm, and vacuum-dried at room temperature for 24 h to produce the PVDF-HFP polymer membrane.

(2) Preparation of a PVDF-HFP-based electrolyte: An electrolyte (2 M LiTFSI in DOL+DME, a volume ratio of DOL to DME was 3:1) was first prepared. Then, the PVDF-HFP polymer membrane was soaked in the electrolyte for 48 h, then dried, and cut to produce the PVDF-HFP-based electrolyte.

(3) Preparation of a cathode: LFP, conductive carbon black, and PVDF were mixed in a mass ratio of 8:1:1 and fully ground, then an appropriate amount of DMF was added, and thorough stirring was conducted to produce a slurry. The slurry was evenly coated onto an aluminum foil. A coated aluminum foil was then vacuum-dried in an oven for 24 h, cut into a disc with a diameter of 10 mm, and stored in a glove box for later use.

(4) Assembly of a lithium metal battery: The cathode and the electrolyte were placed in a glove box, and a CR2032 button battery was then assembled according to the following assembly sequence: cathode shell, cathode, electrolyte, anode, spacer, spring plate, and anode shell.

The charge-discharge performance of the assembled button battery was tested at room temperature using a Land CT3002A battery testing system.

The lithium metal battery was assembled with the polymer electrolyte, and subjected to electrochemical performance tests. The long-term cycling performance data corresponding to Example 1 and Comparative Example 1 was shown in FIG. 2. As shown in FIG. 2, after the lithium metal battery in Example 1 operated at 1 C for 3000 stable cycles, a capacity retention rate was 98% and a Coulombic efficiency was 99.9%. In contrast, the lithium metal battery in Comparative Example 1 had a short cycling life of 277 cycles with a capacity retention rate of 53.8%. It can be seen that the lithium metal battery in Example 1 possesses significantly enhanced cycling stability and outstanding capacity performance.

### Comparative Example 2

(1) Preparation of a PVDF-HFP+PEG polymer membrane: 300 mg of PVDF-HFP and 100 mg of NH₂-PEG-NH₂ were weighed and mixed in a glove box, and then DMF was added for dissolution to produce a precursor solution. The precursor solution was continuously stirred at room temperature for 12 h to produce a homogeneous precursor solution. The homogeneous precursor solution was poured into a glass dish with a diameter of 8 cm, and vacuum-dried at room temperature for 24 h to produce the PVDF-HFP+PEG polymer membrane.

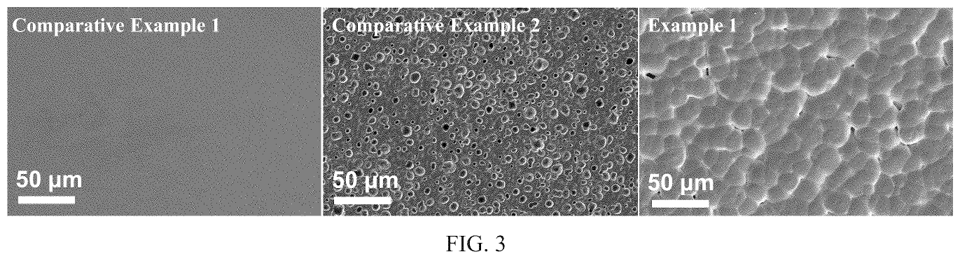

Polymer membrane samples were photographed by SEM. According to the surface SEM images in FIG. 3, the PVDF-HFP-@PEG polymer membrane prepared in Example 1 has a uniform, tightly interconnected porous structure, which is distinctly different from structures of the PVDF-HFP polymer membrane prepared in Comparative Example 1 and the PVDF-HFP+PEG polymer membrane prepared in Comparative Example 2. Moreover, the polymer membrane in Comparative Example 2 has an increased porosity, but undergoes significant phase separation.

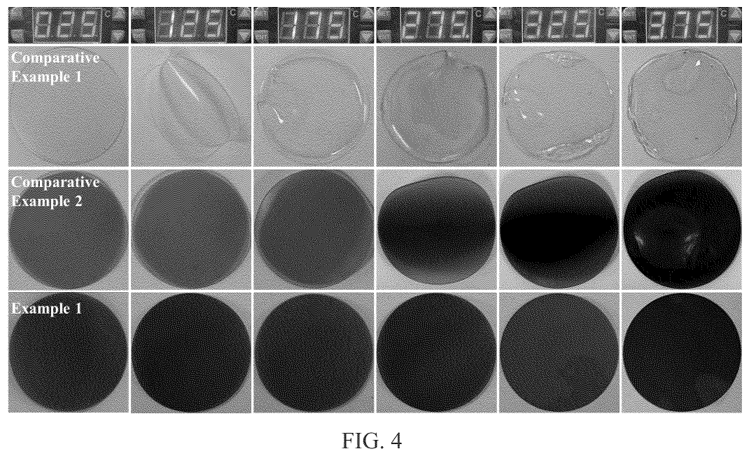

According to the thermal stability test results of the polymer membranes in FIG. 4, the PVDF-HFP polymer membrane prepared in Comparative Example 1 began to curl significantly at 125° C. and began to melt at 175° C. The PVDF-HFP+PEG polymer membrane prepared in Comparative Example 2 began to curl at 175° C. and was partially charred at 275° C. In contrast, the PVDF-HFP-@PEG polymer membrane prepared in Example 1 began to melt when the temperature was as high as 325° C., and underwent obvious overall melting when the temperature reached 375° C. Moreover, the overall shape of the PVDF-HFP-@PEG polymer membrane prepared in Example 1 remained unchanged throughout the process. This intuitively indicates a substantial improvement in thermal stability of the polymer membrane after modification.

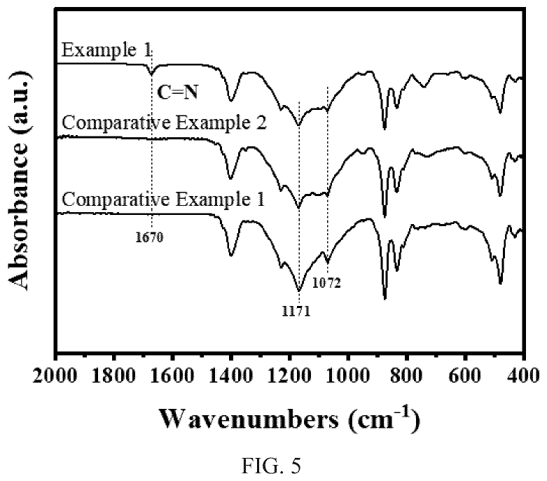

FT-IR spectroscopy was conducted, and results were shown in FIG. 5. According to the comparison of FT-IR spectroscopy results of Example 1 and Comparative Example 2, the weakening of symmetrical stretching vibration peaks of CF₂ (at 1072 cm⁻¹ and 1171 cm⁻¹) and the emergence of a peak at 1670 cm⁻¹ (characteristic peak of an imine bond C═N) confirmed the formation of a crosslinked structure in the PVDF-HFP-@PEG polymer membrane prepared in Example 1, indicating the feasibility of implementing the “slight crosslinking” strategy.

The polymer membranes were each subjected to a mechanical tensile test with an INSTRON 5967 universal material testing machine. As shown in FIG. 6, stress-strain curves of the PVDF-HFP polymer membrane prepared in Comparative Example 1 and the PVDF-HFP+PEG polymer membrane prepared in Comparative Example 2 exhibited distinct Lüders bands, indicating strong plasticity. Additionally, the contribution of a plastic strain to the overall strain was significant throughout the tensile process for these two polymer membranes. However, in a stress-strain curve of the PVDF-HFP-@PEG polymer membrane prepared in Example 1, a Lüders band disappeared. The primary form of strain shifted to elastic deformation. This indicates that the material plasticity declines greatly and the goal of crystallinity lowering is achieved. The addition of the NH₂-PEG-NH₂ plasticizer to the PVDF-HFP matrix reduced the mechanical properties of the polymer membrane. However, the polymer membrane in Example 1 still had an excellent tensile modulus of 14.2 MPa. This polymer membrane exhibited outstanding durability during an operation process of a lithium battery including this polymer membrane. It indicates that the physical and electrochemical properties are synergistically improved.

(2) Preparation of a PVDF-HFP+PEG-based electrolyte: An electrolyte (2 M LiTFSI in DOL+DME, a volume ratio of DOL to DME was 3:1) was first prepared. Then, the PVDF-HFP+PEG polymer membrane was soaked in the electrolyte for 48 h, then dried, and cut to produce the PVDF-HFP+PEG-based electrolyte.

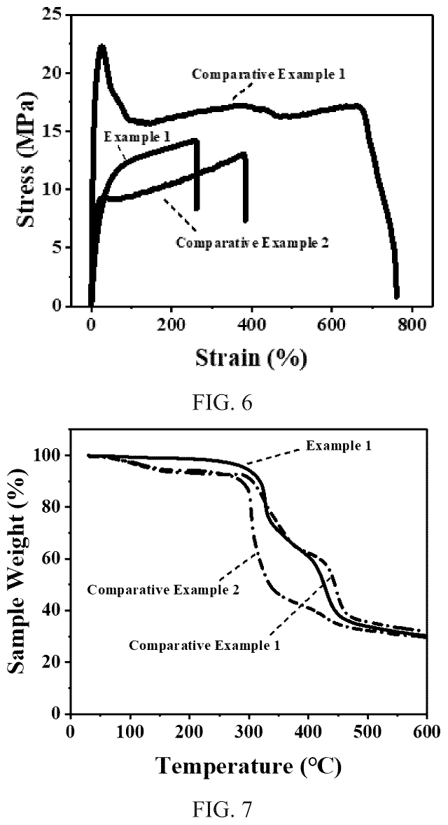

TGA test: A mass loss at 300° C. or lower was primarily attributed to the decomposition of a lithium salt and an electrolyte solvent. As shown in FIG. 7, at a high temperature of 300° C., the PVDF-HFP-@PEG-based electrolyte prepared in Example 1 still had an ultrahigh mass retention rate of 94.3%, indicating excellent electrolyte retention capacity.

### Example 2

(1) Preparation of a PVDF-HFP-@PEG polymer membrane: 500 mg of PVDF-HFP and 100 mg of NH₂-PEG-NH₂ were weighed and mixed in a glove box, and then DMF was added for dissolution to produce a precursor solution. The precursor solution was continuously stirred at room temperature for 12 h to produce a homogeneous precursor solution. The homogeneous precursor solution was poured into a glass dish with a diameter of 8 cm, vacuum-dried at room temperature for 12 h, and then subjected to vacuum crosslinking at 200° C. for 2 h to produce the PVDF-HFP-@PEG polymer membrane.

(2) Preparation of a PVDF-HFP-@PEG-based electrolyte: An electrolyte (1 M LiPF₆ in EC+FEC, a volume ratio of EC to FEC was 3:1) was first prepared. Then, the PVDF-HFP-@PEG polymer membrane was soaked in the electrolyte for 48 h, then dried, and cut to produce the PVDF-HFP-@PEG-based electrolyte.

(3) Preparation of a cathode: A preparation process in this example was the same as the preparation process in Example 1.

(4) Assembly of a lithium metal battery: An assembly process in this example was the same as the assembly process in Example 1.

The charge-discharge performance of the assembled button battery was tested at room temperature using a Land CT3002A battery testing system.

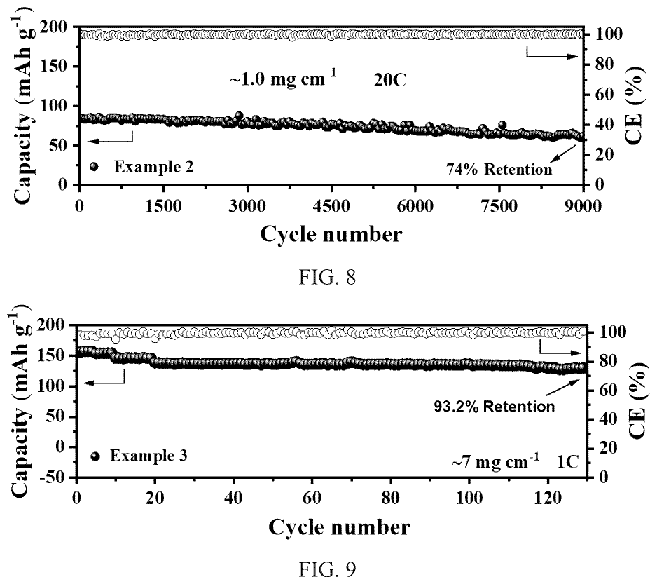

The lithium metal battery was assembled with the electrolyte, and subjected to electrochemical performance tests. The corresponding high-rate long-term cycling performance data was shown in FIG. 8. As shown in FIG. 8, after the lithium metal battery assembled with the electrolyte prepared in Example 2 operated at 20 C for 9000 stable cycles, a capacity retention rate was 74% and a Coulombic efficiency was 99.9%, indicating exceptional performance.

### Example 3

(1) Preparation of a PVDF-HFP-@PEG polymer membrane: 200 mg of PVDF-HFP and 100 mg of NH₂-PEG-NH₂ were weighed and mixed in a glove box, and then DMF was added for dissolution to produce a precursor solution. The precursor solution was continuously stirred at room temperature for 12 h to produce a homogeneous precursor solution. The homogeneous precursor solution was poured into a glass dish with a diameter of 8 cm, vacuum-dried at room temperature for 12 h, and then subjected to vacuum crosslinking at 180° C. for 1 h to produce the PVDF-HFP-@PEG polymer membrane.

(2) Preparation of a PVDF-HFP-@PEG-based electrolyte: An electrolyte (1 M LiFSI in DME+1,1,2,2-Tetrafluoroethyl-2,2,3,3-tetrafluoropropyl ether (TTE), a volume ratio of DME to TTE was 5:1) was first prepared. Then, the PVDF-HFP-@PEG polymer membrane was soaked in the electrolyte for 48 h, then dried, and cut to produce the PVDF-HFP-@PEG-based electrolyte.

(3) Preparation of a cathode: A preparation process in this example was the same as the preparation process in Example 1.

(4) Assembly of a lithium metal battery: An assembly process in this example was the same as the assembly process in Example 1.

The charge-discharge performance of the assembled button battery was tested at room temperature using a Land CT3002A battery testing system.

The lithium metal battery was assembled with the electrolyte, and subjected to electrochemical performance tests. The corresponding high-loading long-term cycling performance data was shown in FIG. 9. As shown in FIG. 9, after the lithium metal battery assembled with the electrolyte prepared in Example 3 operated at a high cathode loading of 7 mg cm⁻¹ for 130 stable cycles, a capacity retention rate was 93.2% and a Coulombic efficiency was 99.9%, indicating excellent performance.

What is claimed is:

1. A preparation method of a poly(vinylidene fluoride-co-hexafluoropropylene) (PVDF-HFP)-@polyethylene glycol (PEG)-based electrolyte, comprising: soaking a PVDF-HFP-@PEG polymer membrane in an electrolyte under an inert atmosphere, and drying to produce the PVDF-HFP-@PEG-based electrolyte, wherein a structural formula of the PVDF-HFP-@PEG polymer membrane is as follows: 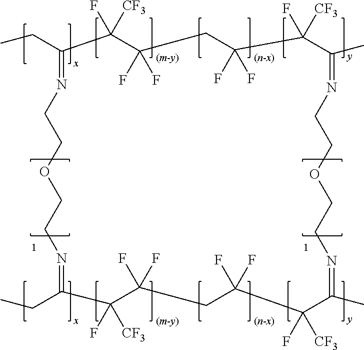
wherein x is a positive integer greater than 0 and less than n, y is a positive integer greater than 0 and less than m, at least one of x and y is greater than or equal to 1, and values of m and n are determined based on PVDF-HFP; and
a preparation process of the PVDF-HFP-@PEG polymer membrane is as follows: 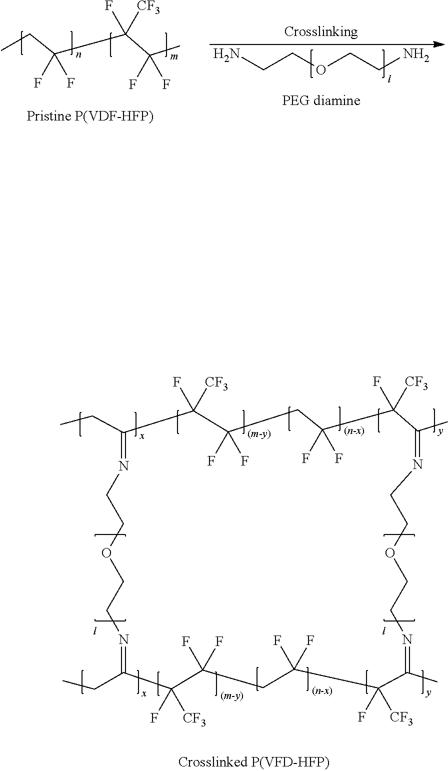
adding the PVDF-HFP and polyethylene glycol diamine (NH₂-PEG-NH₂) to a solvent, and thoroughly mixing to produce a precursor mixed solution; spreading the precursor mixed solution into a thin liquid layer, and vacuum-drying at room temperature; and conducting a crosslinking reaction under vacuum at 130° C. to 230° C. to produce the PVDF-HFP-@PEG polymer membrane, wherein a mass ratio of the PVDF-HFP to the NH₂-PEG-NH₂ is 2-6:1.

2. The preparation method of the PVDF-HFP-@PEG-based electrolyte according to claim 1, wherein the vacuum-drying at room temperature is conducted for 12 h to 48 h, and the crosslinking reaction is conducted for 0.5 h to 5 h.

3. The preparation method of the PVDF-HFP-@PEG-based electrolyte according to claim 2, wherein the solvent is one of N,N-dimethylformamide (DMF), N-methylpyrrolidone (NMP), acetonitrile, N,N-dimethylacetamide (DMAC), dimethyl sulfoxide (DMSO), and hexamethylphosphoramide (HMPA).

4. The preparation method of the PVDF-HFP-@PEG-based electrolyte according to claim 3, wherein the electrolyte comprises a metal salt and an organic solvent, and the metal salt is one of a lithium salt, a sodium salt, and a zinc salt.

5. The preparation method of the PVDF-HFP-@PEG-based electrolyte according to claim 4, wherein the lithium salt is one or more of lithium bis(trifluoromethanesulfonyl)imide, lithium tetrafluoroborate, lithium hexafluorophosphate, lithium perchlorate, lithium bis(oxalato)borate, lithium difluoro(oxalato)borate, and lithium bis(fluorosulfonyl)imide, and a concentration of the lithium salt in the electrolyte is 0.5 mol/L to 3 mol/L; the sodium salt is one or more of sodium hexafluorophosphate, sodium trifluoromethanesulfonate, sodium bis(fluorosulfonyl)imide, sodium bis(trifluoromethanesulfonyl)imide, sodium tetrafluoroborate, sodium bis(oxalato)borate, sodium difluoro(oxalato)borate, and sodium perchlorate, and a concentration of the sodium salt in the electrolyte is 0.5 mol/L to 3 mol/L; the zinc salt is one or more of zinc sulfate and zinc trifluoromethanesulfonate, and a concentration of the zinc salt in the electrolyte is 0.5 mol/L to 3 mol/L; and the organic solvent is one or more of 1,3-dioxolane (DOL), ethylene glycol dimethyl ether, hydrofluoroether, ethylene carbonate (EC), vinylene carbonate (VC), fluoroethylene carbonate (FEC), dimethyl carbonate (DMC), and diethyl carbonate (DEC).

6. A PVDF-HFP-@PEG-based electrolyte prepared by the preparation method according to claim 1.

7. A lithium battery, comprising a cathode, an anode, and the PVDF-HFP-@PEG-based electrolyte according to claim 6, wherein the PVDF-HFP-@PEG-based electrolyte is arranged between the cathode and the anode to assemble the battery.

8. The PVDF-HFP-@PEG-based electrolyte according to claim 6, wherein in the preparation method, the vacuum-drying at room temperature is conducted for 12 h to 48 h, and the crosslinking reaction is conducted for 0.5 h to 5 h.

9. The PVDF-HFP-@PEG-based electrolyte according to claim 8, wherein in the preparation method, the solvent is one of DMF, NMP, acetonitrile, DMAC, DMSO, and HMPA.

10. The PVDF-HFP-@PEG-based electrolyte according to claim 9, wherein in the preparation method, the electrolyte comprises a metal salt and an organic solvent, and the metal salt is one of a lithium salt, a sodium salt, and a zinc salt.

11. The PVDF-HFP-@PEG-based electrolyte according to claim 10, wherein in the preparation method, the lithium salt is one or more of lithium bis(trifluoromethanesulfonyl)imide, lithium tetrafluoroborate, lithium hexafluorophosphate, lithium perchlorate, lithium bis(oxalato)borate, lithium difluoro(oxalato)borate, and lithium bis(fluorosulfonyl)imide, and a concentration of the lithium salt in the electrolyte is 0.5 mol/L to 3 mol/L; the sodium salt is one or more of sodium hexafluorophosphate, sodium trifluoromethanesulfonate, sodium bis(fluorosulfonyl)imide, sodium bis(trifluoromethanesulfonyl)imide, sodium tetrafluoroborate, sodium bis(oxalato)borate, sodium difluoro(oxalato)borate, and sodium perchlorate, and a concentration of the sodium salt in the electrolyte is 0.5 mol/L to 3 mol/L; the zinc salt is one or more of zinc sulfate and zinc trifluoromethanesulfonate, and a concentration of the zinc salt in the electrolyte is 0.5 mol/L to 3 mol/L; and the organic solvent is one or more of DOL, ethylene glycol dimethyl ether, EC, VC, FEC, DMC, and DEC.
